(19) United States
(12) Patent Application Publication
(10) Pub. No.: US 2005/0252258 A1
(43) Pub. Date: Nov. 17, 2005

(54) All terrain vehicle wheel lock

(76) Inventor: James Thomas Peacock, Juneau, AK (US)

Correspondence Address: James Tomas Peacock, P.O. Box 32078, Juneau, AK, 99803, US

(21) Appl. No.: 10/845,062

(22) Filed: May 13, 2004

(51) Int. Cl. B60R 25/00

(52) U.S. Cl. 70/226

(57) ABSTRACT

This is a universally locking device that both immobilizes the vehicle from “push of” theft and also prevents thefts of tires and wheels. With small adaptations this device could also be used on motorcycles and small trailers.

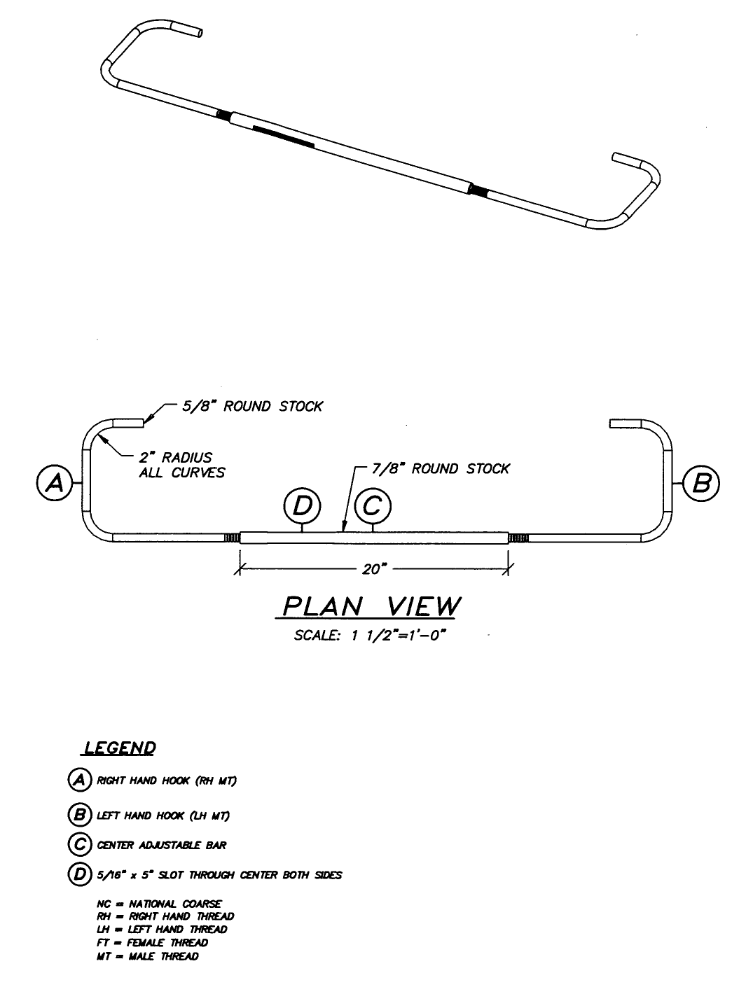

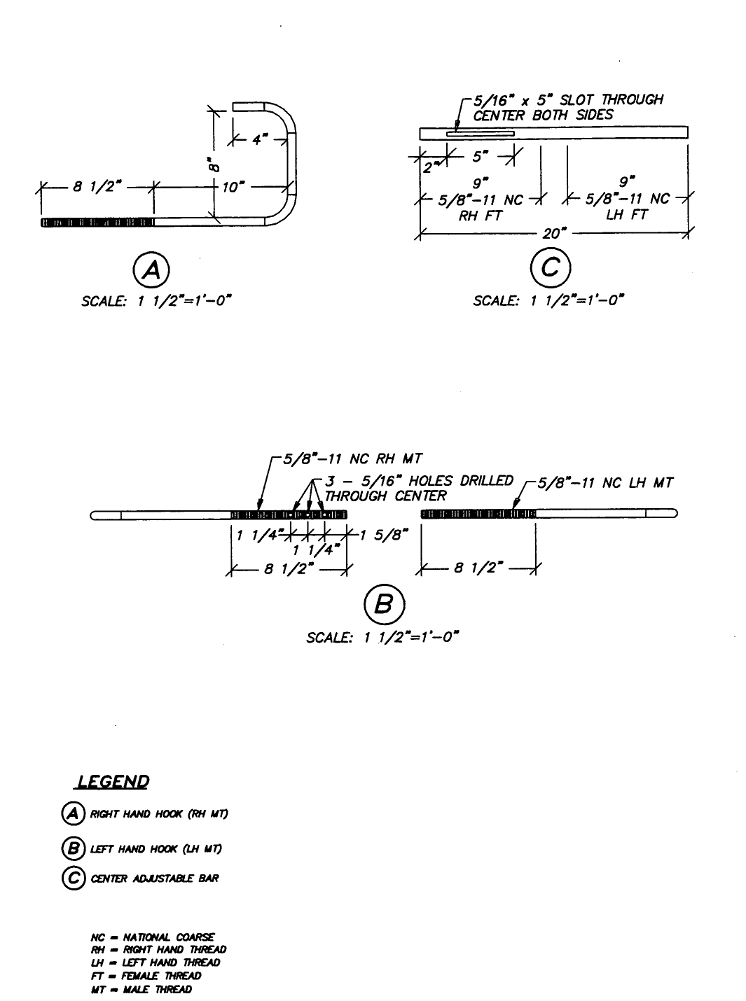

### BACKGROUND

The problem of “push-off” theft of All Terrain Vehicles (hereafter ATVs) as well as other small vehicles and trailers has become increasingly more profound. Another serious problem is theft of expensive ATV wheels and tires.

There are numerous known locking devices to immobilize small vehicles such as ATVs. Most rely on the wheels to have spokes or slots in them and the devices themselves are often complicated and clumsy to use.

Gary A. Thering, U.S. Pat. No. 5,724,839 granted on Mar. 10, 1998 references other patents. These are:

| | | |
|---|---|---|
| 584017 | June 1897 | Sewell |
| 1401971 | January 1922 | Faison |
| 1443009 | January 1923 | Davis |
| 148893 | April 1924 | Plouffe |
| 1504220 | August 1924 | Degen |
| 2844954 | July 1958 | Marugg |
| 3245239 | April 1966 | Zaidener |
| 4768359 | September 1988 | Wade |
| 4833442 | May 1989 | Von Heck |
| 5247815 | September 1993 | Caldwell |
| 5259081 | November 1993 | Henderson |
| 5265449 | November 1993 | Rashleigh |
| 5271636 | December 1993 | Morhman, et. Al. |
| 5372018 | December 1994 | Smith |
| 5460021 | October 1995 | Taylor |
| 5520034 | May 1996 | Edmondson |
| 5628212 | May 1997 | Fritzler |

### Foreign Patent Documents

| | | |
|---|---|---|
| 506328 | August 1920 | FR |
| 16991 | July 1909 | GB |
| 2106058 | April 1983 | GB |
| WO86/05150 | September 1986 | WO |

Carl W. Pierce, U.S. Pat. No. 5,927,108 granted on Jul. 27, 1999 also references other patents. These are:

| | | |
|---|---|---|
| 14488893 | April 1924 | Plouffe |
| 4768359 | September 1988 | Wade |
| 4819462 | April 1989 | Apsell |
| 5134868 | August 1992 | Bethards |
| 5315848 | May 1994 | Beyer |
| 5333477 | August 1994 | Davis |
| 5372018 | December 1994 | Smith |
| 5375442 | December 1994 | Hammer |
| 5437171 | August 1995 | Owen |
| 5520034 | May 1996 | Edmonson |
| 5582044 | December 1996 | Bolich |
| 5613385 | March 1997 | Yamabe |
| 5628212 | May 1997 | Fritzler |
| 5639001 | June 1997 | Brady |
| 5673574 | October 1997 | Bertram |
| 5689981 | November 1997 | DeLuca, et. Al. |
| 5724839 | March 1998 | Thering |
| 5778706 | July 1998 | Testa |

### Foreign Patent Documents

| | | |
|---|---|---|
| 2106058 | April 1983 | GB |
| 86/05150 | September 1986 | WO |

Both Thering's and Pierce's devices are mechanically complicated with numerous individual parts and functions. Thering's device utilizes flat stock, which can be cut and/or distorted to the point that the device can be easily removed from the vehicle. Pierce's device utilizes lightweight tubular stock which can be similarly compromised.

### DESCRIPTION

### BRIEF DESCRIPTION OF THE DRAWINGS

Sheet 1 of 2:

The upper figure shows the locking devise in it's assembled condition. The two “J”-shaped hooks over and around the outer surfaces of either the front or back set of wheels (or both) of the ATV. The lower figure shows more detail of the three essential parts of the locking device.

Sheet 2 of 2:

The upper left figure shows the dimensions of the two “J”-shaped hooks. The upper right figure shows the dimensions of the adjustable center bar. The lower two figures show the differences between the two “J”-shaped hooks.

Both of the above noted sheets have a legend of explanation.

### DETAILED DESCRIPTION OF THE DRAWINGS

Sheet 1 of 2:

The upper figure shows the locking device as noted previously.

The lower figure shows the locking device with the five integral parts:
1. Part A: “J”-shaped hook with right-hand male threads made of ⅝″ solid round stock.
2. Part B: “J”-shaped hook with left-hand male threads made of ⅝″ solid round stock.
3. Part C: Center adjustable bar with right-hand and left-hand female threads made of ⅞″ solid round stock.
4. Part D: 5″× 5/16″ slot through center of Part C.
5. Part E: Three 5/16″ holes through center of threaded part of Part A.

Sheet 2 of 2:

The upper left figure shows the “J”-shaped hook with the inside diameter legs of 4″, 8″, and 18½″ respectively with 8½″ of the longest leg threaded with national coarse male threads (Parts A and B of sheet 1 of 2).

The upper right figure shows the adjustable center bar (Part C) that is 20″ long with 9″ of national coarse female threads at either end and a 5″× 5/16″ slot machined through center and ½″ from the bottom of the threads (Part D of Sheet 1 of 2).

The two lower figures show the differences between the two “J”-shaped hooks in that one hook has 5/5″-11NC right-hand threads (Part A of Sheet 1 of 2) with three 5/16″ holes drilled through center while the opposite “J”-shaped hook has ⅝″-11NC left-hand threads (Part B of Sheet 1 of 2) with no holes.

### SUMMARY OF THE INVENTION

It is the object of this invention to supply means to both immobilize an ATV (or other small vehicles) and to prevent theft of expensive wheels and tires. It is also the object of this invention to simplify and thus improve upon previous ATV locking devices, most notably those of Thering and Pierce as mentioned earlier. This new device is much less complicated (essentially only one moving part) and thus easier to use and less prone to being compromised. This device would be manufactured out of solid, quality grade stainless steel, which is extremely hard to cut or distort by mechanical methods and is both durable and anti-corrosive.

1. A universally useable ATV wheel lock that is composed of two “J”-shaped hooks of sufficient design and measurement to accommodate all standard ATV wheels and tires and one adjustable bar to accommodate slight differences in wheel base dimensions. The two “J”-shaped hooks are placed around and over either the front or rear set of wheels and the center bar (through the use of the right-hand and left-hand thread design) is tightened to secure the wheels. A padlock is then inserted through the slot (Part D) in the adjustable bar (Part C) and a hole hole (Part E) in one of the “J”-shaped hooks thus preventing further movement of the adjustable bar and consequentially locking the device to the ATV.

2. Once the locking device of claim 1 is secured to the ATV, the vehicle cannot be moved more than a few feet before the locking device strikes a body part (frame) thus immobilizing the ATV.

3. Furthermore, once the locking device of claim 1 is secured to the vehicle the wheels cannot be removed from the ATV.
